(19) United States
(12) Patent Application Publication
(10) Pub. No.: US 2005/0237042 A1
(43) Pub. Date: Oct. 27, 2005

(54) Switching power supply circuit and semiconductor device integrating the same

(75) Inventors: Masato Yoshida, Takatsuki-shi (JP); Takashi Ryu, Kyoto-shi (JP); Kazuyuki Moritake, Takatsuki-shi (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Matsushita Electric Industrial Co., Ltd.

(21) Appl. No.: 11/106,085

(22) Filed: Apr. 14, 2005

(30) Foreign Application Priority Data
Apr. 21, 2004 (JP) 2004-125271

(51) Int. Cl. H02M 3/335; G05F 1/40

(52) U.S. Cl. 323/282

(57) ABSTRACT

A switching power supply circuit in accordance with the present invention is configured such that a switched-capacitor circuit is provided between an output terminal for outputting an output voltage and an input of an error amplification circuit, the output signal from the error amplification circuit for amplifying the error between a DC output voltage and a reference voltage is compared with a reference signal by a pulse width modulation circuit, and a voltage conversion section is turned ON/OFF continuously using the output signal of a pulse width modulation circuit while having a predetermined period with respect to an input voltage.

### BACKGROUND OF THE INVENTION

The present invention relates to a switching power supply circuit, and more particularly, to a switching power supply circuit capable of being integrated inside a semiconductor device.

In recent years, portable electronics apparatuses, such as portable telephones and digital still cameras, are requested to be made more compact in size, lighter in weight and lower in cost. A switching power supply circuit configured using a semiconductor integrated circuit has been used as the power supply circuit for such a portable electronics apparatus. FIG. 7 is a block diagram showing the configuration of a switching power supply circuit in accordance with a conventional technology.

The switching power supply circuit in accordance with the conventional technology will be described below referring to the accompanying drawings.

In the conventional switching power supply circuit shown in FIG. 7, a power input terminal 1 to which a DC voltage is input and an output terminal 2 from which a predetermined DC output voltage is output are provided for a voltage conversion section 3. The voltage conversion section 3 comprises a power transistor 53, a coil 54, a diode 55 and an output smoothing capacitor 56. In addition, this switching power supply circuit is provided with a pre-drive circuit 4, a pulse width modulation circuit 5, an error amplification circuit 6, a reference voltage circuit 7 for generating a reference voltage, a reference signal generation circuit 8 for generating a reference signal, and output voltage setting resistors 50 and 51. Furthermore, a capacitor 52 is connected across the input and output of the error amplification circuit 6. In the conventional switching power supply circuit configured as described above, a stable DC output voltage is output from the output terminal 2 by virtue of negative feedback operation.

The negative feedback operation in the conventional switching power supply circuit configured as shown in FIG. 7 will be described using FIG. 8. FIG. 8 is a frequency characteristic graph showing the relationship between the gain and the phase in the conventional switching power supply circuit configured as described above.

In the conventional switching power supply circuit, the DC output voltage is divided by the output voltage setting resistors 50 and 51, and a voltage proportional to the DC output voltage is detected as a detected voltage. This detected voltage is compared with the reference voltage from the reference voltage circuit 7 by the error amplification circuit 6. When the detected voltage is higher than the reference voltage, the output voltage of the error amplification circuit 6 is lowered. The lowered output voltage of the error amplification circuit 6 is input to the pulse width modulation circuit 5 and compared with the reference signal of the reference signal generation circuit 8. In this case, the output voltage of the error amplification circuit 6 becomes lower than the reference signal of the reference signal generation circuit 8. Hence, the pulse width modulation circuit 5 outputs a pulse signal that shortens the conduction time of the power transistor 53 of the voltage conversion section 3 to the voltage conversion section 3 via the pre-drive circuit 4. As a result, the DC output voltage generated at the power output terminal 2 of the voltage conversion section 3 is lowered.

On the other hand, when the detected voltage is lower than the reference voltage, the output voltage of the error amplification circuit 6 is raised. The raised output voltage of the error amplification circuit 6 is input to the pulse width modulation circuit 5 and compared with the reference signal of the reference signal generation circuit 8. In this case, the output voltage of the error amplification circuit 6 becomes higher than the reference signal of the reference signal generation circuit 8. Hence, the pulse width modulation circuit 5 outputs a pulse signal that lengthens the conduction time of the power transistor 53. As a result, the DC output voltage generated at the output terminal 2 of the voltage conversion section 3 is raised. As described above, the switching power supply circuit carries out negative feedback operation in which the DC output voltage is level-controlled so as to reduce the error between the detected voltage of the DC output voltage and the reference voltage. As a result, the DC output voltage becomes a predetermined value and stabilizes.

Stability of the negative feedback operation will be described below using FIGS. 7 and 8. In FIG. 7, the capacitor 52 is connected across the input and output of the error amplification circuit 6. This capacitor 52 functions as a feedback capacitance, and the error amplification circuit 6 functions as an integrating-type amplification circuit. FIG. 8 shows two frequency characteristic curves obtained when feedback capacitances are different, and is a characteristic graph wherein the feedback capacitance for the gain-phase characteristic 1 is set so as to be larger than that for the gain-phase characteristic 2.

The case of the gain-phase characteristic 2, indicated by broken lines in FIG. 8, wherein the feedback capacitance across the input and output of the error amplification circuit 6 is small will be described below. In this case, amplification operation is carried out at raw gain (gain in the state of no negative feedback) at frequencies not higher than the cutoff frequency fc (at pole P2). On the other hand, at frequencies higher than the cutoff frequency fc (at pole P2), the gain is lowered at the rate of −6 dB/octave as the frequency is higher. When the frequency at which the gain of the error amplification circuit 6 is 0 dB (1-time amplification degree) is defined as zero-cross frequency fz0, the value of the impedance of the capacitor 52 having a capacitance C2 (feedback capacitance), 1/(2π×fz0×C2), is equal to the value of the input resistor Zi connected to the input of the error amplification circuit 6 at this zero-cross frequency fz0. At frequencies higher than this zero-cross frequency fz0, the error amplification circuit 6 functions as an attenuator. Since the input resistor Zi connected to the input of the error amplification circuit 6 should be regarded as a resistor connected in parallel with the resistors 50 and 51, the zero-cross frequency fz0 in the case of the gain-phase characteristic 2 can be represented by the following expression (1).
fz0=1/(2π×Zi×C2) (1)

On the other hand, a secondary LC filter is generated at a resonance frequency fL determined by the coil 54 having an inductance L1 and the output smoothing capacitor 56 having a capacitance C1 in the voltage conversion section 3. The resonance frequency fL is represented by the following expression (2).
fL=1/(2π×\sqrt{(L1×C1)} (2)

This gain characteristic and this phase characteristic are represented by the gain-phase characteristic 2 indicated by the broken lines in FIG. 8. In FIG. 8, the frequency at which the gain is 0 dB is represented by the zero-cross frequency fz0.

In the phase characteristic, at a frequency higher than 1/10 of the cutoff frequency fc (pole P2), the phase begins to advance. At the cutoff frequency fc, the phase advances 45°. At a frequency 10 times as high as the cutoff frequency fc, the phase advances approximately 90°.

In the case that the switching power supply circuit has such a characteristic as represented by the above-mentioned gain-phase characteristic 2 and that the resonance frequency fL is lower than the zero-cross frequency fz0, the following problem will occur.

The pulse width modulation circuit 5 compares the output signal of the reference signal generation circuit 8 with the output signal of the error amplification circuit 6 and generates a PWM signal, the pulse width of which is controlled depending on the error in the comparison. The power transistor 53 is subjected to chopping operation via the pre-drive circuit 4 for pre-driving the PWM signal. The chopping signal generated at this time is smoothed by the coil 54 and the capacitor 56 constituting the voltage conversion section 3 and converted into the DC output voltage. When the chopping operation is carried out, a ringing phenomenon occurs at the resonance frequency fL. The ringing signal generated by this ringing phenomenon is further amplified by the error amplification circuit 6. Then, the pulse width modulation circuit 5 compares the amplified ringing signal with the reference signal and then generates a chopping signal. Hence, if the ringing phenomenon occurs each time the chopping operation is carried out, a phenomenon similar to an oscillation phenomenon occurs. As a result, the operation of the entire circuit becomes unstable.

For the purpose of solving this problem, the capacitance C2 of the capacitor 52 is set higher, the zero-cross frequency is changed from fz0 to a lower frequency fz1 and is set so that the relationship of fz1<fL is established as represented by the gain-phase characteristic 1 indicated by the solid lines in FIG. 8. In the state of the gain-phase characteristic 1 shown in FIG. 8, the gain of the error amplification circuit 6 is 0 dB or less at the resonance frequency fL, whereby the error amplification circuit 6 functions as an attenuator. This stabilizes the circuit operation of the negative feedback path. For the purpose of stabilizing the negative feedback operation, Japanese Patent No. 3190914, for example, has disclosed a circuit wherein a phase correction circuit is provided across the input and output of an error amplification circuit shown in FIG. 7 of its description so as to form an integrating-type error amplification circuit.

However, semiconductor integrated circuits being used inside portable apparatuses, such as portable telephones and digital still cameras, are requested to be made more compact in size and lighter in weight, also requested to be made higher in information processing speed and further requested to be made lower in cost. Therefore, the switching power supply circuit is also requested to be made more compact in size, lighter in weight, higher in speed and lower in cost. In the switching power supply circuit, generally speaking, the inductance L1 of the coil 54 is 47 μH or less, and the capacitance C1 of the output smoothing capacitor 56 is 47 μF or less because of restrictions in output load current and component mounting space. Hence, the resonance frequency fL is approximately 4 kHz. Furthermore, for the purpose of stabilizing the negative feedback operation of the conventional switching power supply circuit, the zero-cross frequency fz1 in the integrating-type error amplification circuit is required to have a relationship of fz1<4 kHz.

When it is assumed that the value of the input resistor Zi of the error amplification circuit 6 is approximately 100 kΩ, the capacitance C2 of the capacitor 52 is approximately 400 pF according to the expression (1), and a very large negative feedback capacitance is required. A capacitance mountable on a semiconductor integrated circuit is generally up to 50 pF. In the case of a capacitance larger than that, a configuration wherein a capacitor having such a capacitance is connected externally to the package is adopted. Therefore, such a large feedback capacitance has a problem of increasing the number of external components in a semiconductor integrated circuit on which a switching power supply circuit is integrated.

In addition, for the purpose of stably operating the entire circuit, the gain characteristic in a high frequency region is required to be lowered. This causes a problem of degrading transient response in the high frequency region.

Furthermore, the output load current and the component space are different for each portable electronic apparatus, and the inductance L1 of the coil 54 and the capacitance C1 of the output smoothing capacitor 56 are changed for each electronic apparatus. Hence, the resonance frequency fL becomes different for each electronic apparatus. Therefore, the feedback capacitance is required to be optimized for each electronic apparatus, and the time for developing an optimized semiconductor integrated circuit has become a factor of delaying the development period for the electronic apparatus.

### SUMMARY OF THE INVENTION

For the purpose of solving the problems encountered in the switching power supply circuit in accordance with the above-mentioned conventional technology, the present invention is intended to provide a switching power supply circuit capable of stabilizing negative feedback operation using a small capacitance mountable on a semiconductor integrated circuit, and thereby making it possible to reduce production cost.

For the purpose of attaining the above-mentioned object, a switching power supply circuit in accordance with a first aspect of the present invention is a switching power supply circuit for outputting a predetermined DC output voltage by carrying out chopping operation in which energy is stored in a coil and the stored energy is discharged from the coil, comprising:
an error amplification circuit for amplifying the error between the DC output voltage and a reference voltage,
a first capacitor connected across the input and output terminals of the error amplification circuit,
a pulse width modulation circuit for comparing a reference signal having an inclined waveform with the output signal of the error amplification circuit and for outputting a PWM signal,
a voltage conversion section, including at least the coil and a second capacitor for smoothing the energy discharged from the coil, for outputting the predetermined DC output voltage to a power output terminal by carrying out the chopping operation according to the PWM signal, and
a switched-capacitor circuit provided between the power output terminal and the input terminal of the error amplification circuit. Since the switched-capacitor circuit functions as an input resistor having a large value, the switching power supply circuit in accordance with the present invention configured as described above can sufficiently lower the zero-cross frequency as a transmission characteristic of negative feedback loop, and carry out stable negative feedback operation using a small feedback capacitance. Hence, the switching power supply circuit including the feedback capacitance can be integrated.

In addition, a switching power supply circuit in accordance with a second aspect of the present invention may be characterized in that a third capacitor is provided across the input and output terminals of the switched-capacitor circuit in accordance with the above-mentioned first aspect. The switching power supply circuit in accordance with the present invention configured as described above can stabilize negative feedback operation and can also improve transient response in a high frequency region.

Furthermore, a switching power supply circuit in accordance with a third aspect of the present invention may be characterized in that the reference signal in accordance with the above-mentioned first or second aspect is a triangular wave signal or a sawtooth wave signal generated by a reference signal generation circuit.

Moreover, a switching power supply circuit in accordance with a fourth aspect of the present invention may be characterized in that the sampling frequency of the switched-capacitor circuit in accordance with the above-mentioned first or second aspect is synchronized with the frequency of the reference signal. The switching power supply circuit in accordance with the present invention configured as described above can set a zero-cross frequency as desired by changing frequencies of the reference signal.

Still further, a switching power supply circuit in accordance with a fifth aspect of the present invention may further comprise a frequency divider circuit for dividing the frequency of the reference signal in accordance with the above-mentioned first or second aspect, wherein the switched-capacitor circuit is subjected to sampling operation using the output signal of the frequency divider circuit. The switching power supply circuit in accordance with the present invention configured as described above can lower the sampling frequency of the switched-capacitor circuit at the rate of the dividing ratio of the frequency divider circuit without lowering the frequency of the reference circuit. As a result, measures against oscillation of negative feedback operation can be taken easily without sacrificing the response to load fluctuation.

For the purpose of attaining the above-mentioned object, a semiconductor device in accordance with a sixth aspect of the present invention is a semiconductor device integrating a switching power supply circuit for outputting a predetermined DC output voltage by carrying out chopping operation in which energy is stored in a coil and the stored energy is discharged from the coil, comprising:
an error amplification circuit for amplifying the error between the DC output voltage and a reference voltage,
a first capacitor connected across the input and output terminals of the error amplification circuit,
a pulse width modulation circuit for comparing a reference signal having an inclined waveform with the output signal of the error amplification circuit and for outputting a PWM signal,
a voltage conversion section, including at least the coil and a second capacitor for smoothing the energy discharged from the coil, for outputting the predetermined DC output voltage to a power output terminal by carrying out the chopping operation according to the PWM signal, and
a switched-capacitor circuit provided between the power output terminal and the input terminal of the error amplification circuit, wherein
at least the error amplification circuit, the first capacitor, the pulse width modulation circuit and the switched-capacitor circuit are formed inside one semiconductor substrate. Since the consistency of the capacitor formed inside the switched-capacitor circuit and the first capacitor is excellent, in the switching power supply circuit in the semiconductor device in accordance with the present invention, the frequency characteristic of the negative feedback loop can be set without being influenced by variation during production. On the other hand, since the switched-capacitor circuit functions as an input resistor having a large value, the switching power supply circuit in the semiconductor device in accordance with the present invention configured as described above can carry out stable negative feedback operation using a small feedback capacitance. Hence, the semiconductor device for this switching power supply can be manufactured with smaller variation during production, and the production cost thereof can be reduced.

In addition, since the above-mentioned switching power supply circuit in accordance with the present invention is integrated, in the semiconductor device in accordance with the present invention, switching power supply circuits having uniform characteristics can be provided.

In addition, the input resistance of the error amplification circuit can be made very large by using the switched-capacitor circuit having a capacitance, and the zero-cross frequency can be shifted to the low frequency region side. As a result, stable negative feedback operation for stabilizing DC output voltage can be carried out. The low frequency region in the present invention is a region having relatively low frequencies, that is, frequencies not more than a frequency of 1 kHz as a guide. Moreover, the semiconductor device in accordance with the present invention may be configured such that a frequency divider circuit for dividing the frequency of the reference signal is provided and the switched-capacitor circuit is subject to sampling operation using the output signal of the frequency divider circuit. The semiconductor device in accordance with the present invention as described above can lower the sampling frequency of the switched-capacitor circuit at the rate of the dividing ratio of the frequency divider circuit without lowering the frequency of the reference circuit. As a result, measures against oscillation of negative feedback operation can be taken easily without sacrificing the response to load fluctuation.

In the switching power supply circuit in accordance with the present invention, the capacitor connected in parallel with the switched-capacitor circuit can decrease the input impedance of the error amplification circuit in the high frequency region. Hence, the transient response in the high frequency region can be improved. The high frequency region is a region having relatively high frequencies, that is, frequencies not less than a frequency of 100 kHz as a guide.

In the switching power supply circuit in accordance with the present invention, since the sampling frequency of the switched-capacitor circuit is synchronized with the frequency of the reference signal, the zero-cross frequency can be set as desired by changing the frequency of the reference signal.

The switching power supply circuit in accordance with the present invention can carry out stable negative feedback operation using a small capacitance mountable on a semiconductor integrated circuit. Hence, the transient response at the high frequency region can be improved, and the production cost can be reduced.

The present invention can thus provide a switching power supply circuit being compact in size, light in weight and high in reliability.

In the switching power supply circuit in accordance with the present invention, the input resistance of the error amplification circuit can be made very large by incorporating the switched-capacitor circuit. Even if the value of feedback capacitance connected across the input and output terminals of the error amplification circuit is made small, the zero-cross frequency can be set at a low frequency. Hence, the switching power supply circuit including the feedback capacitance can be integrated on a semiconductor device.

Furthermore, in the switching power supply circuit in accordance with the present invention, the capacitor connected in parallel with the switched-capacitor circuit can decrease the input impedance in the high frequency region. Hence, the transient response in the high frequency region can be improved. Moreover, since the sampling frequency of the switched-capacitor circuit is synchronized with the frequency of the reference signal, the zero-cross frequency can be set as desired by changing the frequency of the reference signal.

Still further, in the semiconductor device in accordance with the present invention, since the switching power supply circuit having the above-mentioned effects is integrated, there is provided a semiconductor device being compact in size, light in weight and high in reliability that can be mass-produced with small variation during production and can be operated stably.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a block diagram showing the configuration of a switching power supply circuit in accordance with Embodiment 1 of the present invention;

FIG. 2 is a frequency characteristic graph showing the gain-phase characteristic of the switching power supply circuit in accordance with Embodiment 1 of the present invention;

FIG. 3 is a block diagram showing the configuration of a step-up switching power supply circuit to which the configuration of the switching power supply circuit in accordance with Embodiment 1 of the present invention is applied;

FIG. 4 is a block diagram showing the configuration of a polarity inverting switching power supply circuit to which the configuration of the switching power supply circuit in accordance with Embodiment 1 of the present invention is applied;

FIG. 5 is a block diagram showing the configuration of a switching power supply circuit in accordance with Embodiment 2 of the present invention;

FIG. 6 is a block diagram showing the configuration of a switching power supply circuit in accordance with Embodiment 3 of the present invention;

FIG. 7 is the block diagram showing the configuration of the conventional switching power supply circuit; and

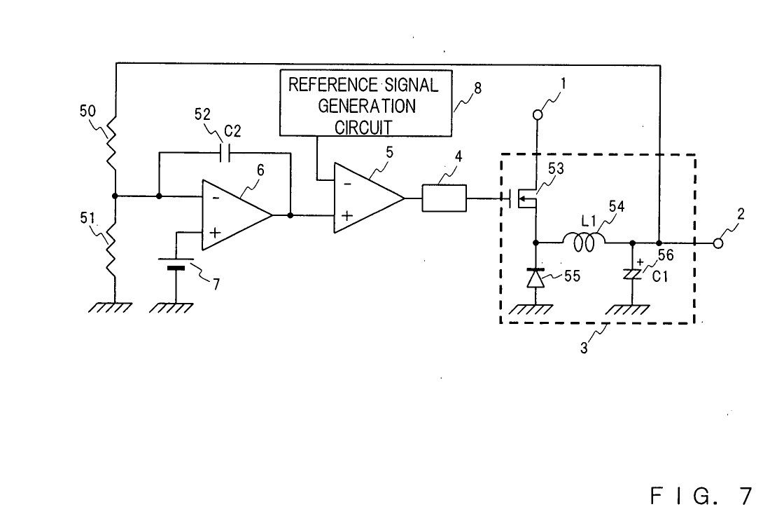

FIG. 8 is the frequency characteristic graph showing the gain-phase characteristic of the conventional switching power supply circuit.

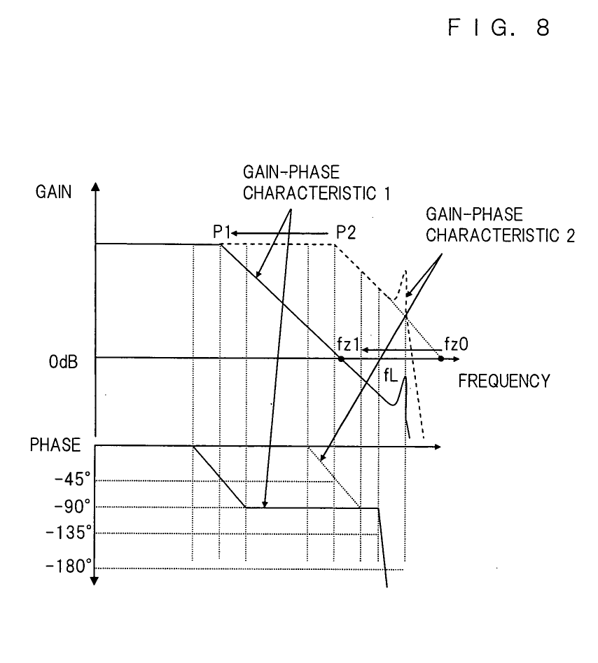

It will be recognized that some or all of the figures are schematic representations for purposes of illustration and do not necessarily depict the actual relative sizes or locations of the elements shown.

### DETAILED DESCRIPTION OF THE INVENTION

Preferred embodiments of a switching power supply circuit in accordance with the present invention will be described below in detail referring to the accompanying drawings.

### Embodiment 1

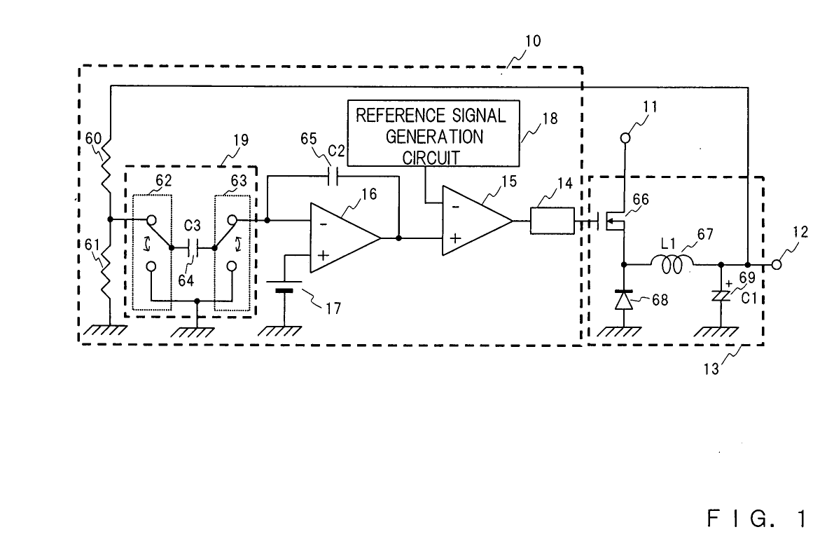

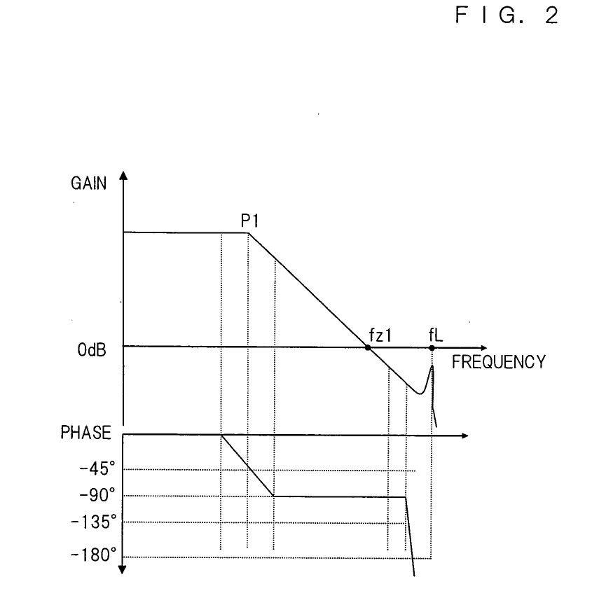

FIG. 1 is a block diagram showing the configuration of a switching power supply circuit in accordance with Embodiment 1 of the present invention. FIG. 2 is a frequency characteristic graph showing the gain-phase characteristic of the switching power supply circuit in accordance with Embodiment 1 of the present invention.

As shown in FIG. 1, the switching power supply circuit in accordance with Embodiment 1 is provided with a power input terminal 11 to which a DC voltage is input and a power output terminal 12 from which a DC output voltage stabilized at a predetermined value is output. These power input terminal 11 and power output terminal 12 are provided for a voltage conversion section 3 comprising a power transistor 66, a coil 67, a diode 68 and an output smoothing capacitor 69. In addition, this switching power supply circuit is provided with a drive signal control section 10 for subjecting the power transistor 66 to ON/OFF operation (chopping operation) using a pulse-width modulated pulse signal. The drive signal control section 10 comprises a pre-drive circuit 14, a pulse width modulation circuit 15, an error amplification circuit 16, a reference voltage circuit 17 for generating a reference voltage, a reference signal generation circuit 18 for generating a reference signal, output voltage setting resistors 60 and 61, and a switched-capacitor circuit 19.

As shown in FIG. 1, a capacitor 65 having a capacitance C2 is provided across the input and output of the error amplification circuit 16. The reference signal generated by the reference signal generation circuit 18 is a signal having an inclined waveform, such as a triangular waveform or a sawtooth waveform, and the waveform is repeated at a predetermined frequency.

The switched-capacitor circuit 19 is provided between the connection point of the output voltage setting resistors 60 and 61 and the inverting input terminal, one of the input terminals, of the error amplification circuit 16. The switched-capacitor circuit 19 comprises switches 62 and 63 being operated ON/OFF in synchronization with a sampling frequency fs, and a capacitor 64 having a capacitance C3. The sampling frequency fs is synchronized with the operation frequency of the reference signal output from the reference signal generation circuit 18.

Furthermore, the zero-cross frequency fz1 shown in FIG. 2 is a frequency determined by the sampling frequency fs of the sampling signal of the switched-capacitor circuit 19 shown in FIG. 1, the capacitance C3 of the capacitor 64 and the capacitance C2 (feedback capacitance) of the capacitor 65. Moreover, the frequency fL is a resonance frequency determined by the inductance L1 of the coil 67 and the capacitance C1 of the output smoothing capacitor 69 of the voltage conversion section 13. In FIG. 2, the zero-cross frequency fz1 is required to be set in a frequency region lower than the resonance frequency fL (fz1<fL).

The operation of the switching power supply circuit in accordance with Embodiment 1 configured as described above will be described below.

The equivalent resistance R of the switched-capacitor circuit 19, determined by the sampling frequency fs of the switched-capacitor circuit 19 and the capacitance C3 of the capacitor 64, can be represented by the following expression (3).
R=1/(fs×C3) (3)

Hence, the relationship of Zi<R can be set by setting the capacitance C3 of the capacitor 64 at a small value. The zero-cross frequency fz1 can be determined using the equivalent resistance R of the switched-capacitor circuit 19 and the feedback capacitance of the error amplification circuit 16. At the zero-cross frequency fz1 wherein the gain of the error amplification circuit 16 is 0 dB, the impedance of the capacitor 65, 1/(2π×fz1×C2), is equal to the equivalent resistance R. Hence, the zero-cross frequency fz1 can be represented by the following expression (4) on the basis of the expression (3).
fz1=(1/2π)×(C3/C2)×fs (4)

The zero-cross frequency fz1 can be set easily in a frequency region lower than the resonance frequency fL determined by the inductance L1 of the coil 67 and the capacitance C1 of the output smoothing capacitor 69 by setting the capacitance ratio of the capacitance C3 of the capacitor 64 of the switched-capacitor circuit 19 and the capacitance C2 of the capacitor 65 serving as the feedback capacitance of the error amplification circuit 16. Since the gain of the error amplification circuit 16 is 0 dB or less at the resonance frequency fL as shown in FIG. 2, the ringing phenomenon generated in the voltage conversion section 13 can be attenuated. Hence, the entire switching power supply circuit can be operated stably.

In the switching power supply circuit in accordance with Embodiment 1, the capacitance C3 of the capacitor 64 of the switched-capacitor circuit 19 and the feedback capacitance of the error amplification circuit 16 can be designed so as to have small values. Since a capacitor having small capacitance has a small flat-shape when the capacitor is mounted on a semiconductor substrate, it is easy to mount devices having such capacitances on a semiconductor integrated circuit. Hence the configuration of the switching power supply circuit in accordance with Embodiment 1 has excellent economic efficiency and stability.

In the switching power supply circuit in accordance with Embodiment 1, the drive signal control section 10 is integrated in a semiconductor device, and the power transistor 66 and the diode 68 are integrated in the semiconductor device according to the specification of the output load thereof. Therefore, it is possible to provide a semiconductor device being compact in size, light in weight and high in reliability.

The switching power supply circuit in accordance with Embodiment 1 has been described as a step-down switching power supply circuit for stepping down DC output voltage from its input voltage. However, the present invention is not limited to have this kind of configuration, but applicable to a step-up switching power supply circuit for stepping up DC output voltage from its input voltage and a polarity inverting switching power supply circuit for outputting DC output voltage (negative DC output voltage), the polarity of which is inverted with respect to its input voltage.

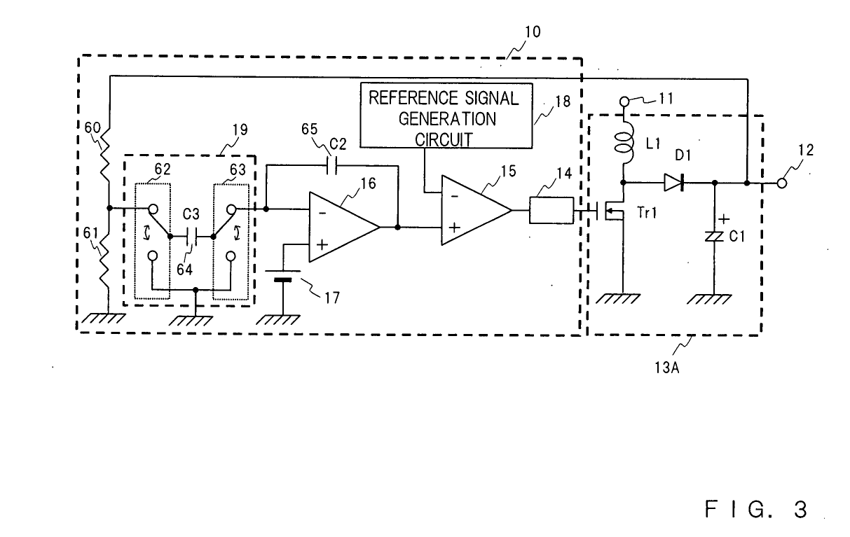

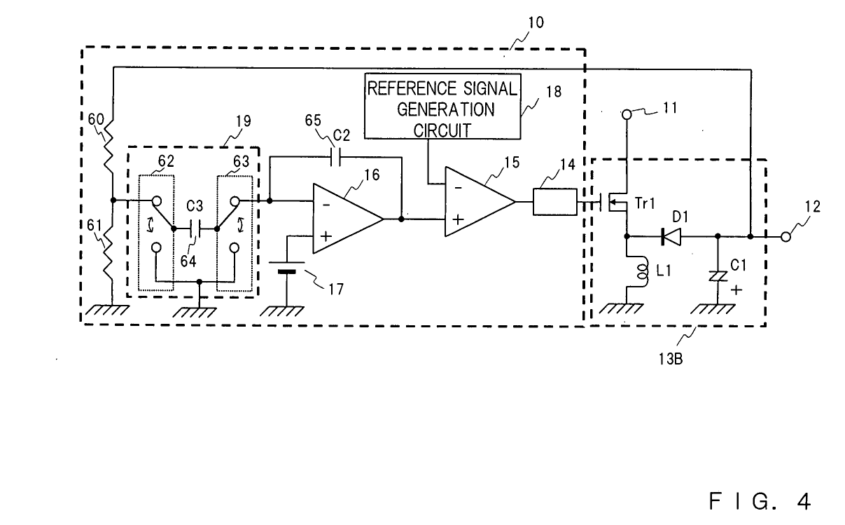

FIG. 3 is a block diagram showing the configuration of a step-up switching power supply circuit to which the configuration of the switching power supply circuit in accordance with Embodiment 1 is applied. FIG. 4 is a block diagram showing the configuration of a polarity inverting switching power supply circuit to which the configuration of the switching power supply circuit in accordance with Embodiment 1 is applied. In FIGS. 3 and 4, the drive signal control section 10 has the same configuration as that of the step-down switching power supply circuit shown in FIG. 1. In the voltage conversion section 13A of the step-up switching power supply circuit shown in FIG. 3, a power transistor Tr1 carries out chopping operation according to the output signal of the drive signal control section 10. And when the power transistor Tr1 is turned on, energy is stored in the coil L1; and when the power transistor Tr1 is turned off, the energy stored in the coil L1 is rectified via a diode D1. As a result, raised DC output voltage is output to the power output terminal 12. In the voltage conversion section 13B of the polarity inverting switching power supply circuit shown in FIG. 4, the power transistor Tr1 carries out chopping operation according to the output signal of the drive signal control section 10. And when the power transistor Tr1 is turned on, energy is stored in the coil L1; and when the power transistor Tr1 is turned off, the energy stored in the coil L1 is rectified via the diode D1. As a result, negative DC output voltage is output to the power output terminal 12.

### Embodiment 2

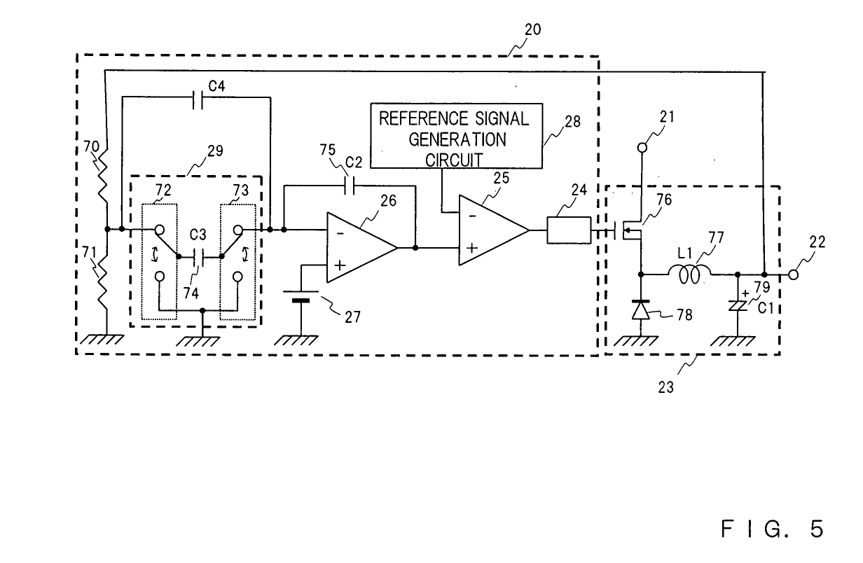

FIG. 5 is a block diagram showing the configuration of a switching power supply circuit in accordance with Embodiment 2 of the present invention.

As shown in FIG. 5, the switching power supply circuit in accordance with Embodiment 2 has a configuration wherein a capacitor 90 is additionally provided in parallel with a switched-capacitor circuit 29 in the configuration of the switched-capacitor circuit in accordance with the above-mentioned Embodiment 1.

The switching power supply circuit in accordance with Embodiment 2 is provided with an input terminal 21 to which a DC voltage is input and an output terminal 22 from which a predetermined DC output voltage is output. These input terminal 21 and output terminal 22 are provided for a voltage conversion section 23 comprising a power transistor 76, a coil 77, a diode 78 and an output smoothing capacitor 79. In addition, this switching power supply circuit is provided with a drive signal control section 20 for subjecting the power transistor 76 to ON/OFF operation (chopping operation) using a pulse-width modulated pulse signal. The drive signal control section 20 comprises a pre-drive circuit 24, a pulse width modulation circuit 25, an error amplification circuit 26, a reference voltage circuit 27 for generating a reference voltage, a reference signal generation circuit 28 for generating a reference signal, output voltage setting resistors 70 and 71, the switched-capacitor circuit 29, and the capacitor 90 having a capacitance C4 and connected across the input and output of the switched-capacitor circuit 29.

As shown in FIG. 5, a capacitor 75 having a capacitance C2 (feedback capacitance) is connected across the input and output of the error amplification circuit 26, that is, in parallel with the error amplification circuit 26. The reference signal generated by the reference signal generation circuit 28 is a signal having an inclined waveform, such as a triangular waveform or a sawtooth waveform, and the waveform is repeated at a predetermined frequency.

The switched-capacitor circuit 29 is provided between the connection point of the output voltage setting resistors 70 and 71 and the inverting input terminal, one of the input terminals, of the error amplification circuit 26. The switched-capacitor circuit 29 comprises switches 72 and 73 being operated ON/OFF in synchronization with a sampling frequency fs, and a capacitor 74 having a capacitance C3.

As described in the description of the switched-capacitor circuit 19 in accordance with the above-mentioned Embodiment 1, the impedance across the input and output of the switched-capacitor circuit 29 in accordance with Embodiment 2 equivalently functions as a resistor having a large resistance value. Hence, the response of the error amplification circuit 26 functioning as an integrating-type amplification circuit in a high frequency region is degraded. However, the response in the high frequency region in particular is improved by connecting the capacitor 90 across the input and output of the switched-capacitor circuit 29 so as to be in parallel therewith. Therefore, the switched-capacitor circuit in accordance with Embodiment 2 attains stable negative feedback operation for stabilizing DC output voltage and also attains an excellent transient response characteristic even in the high frequency region.

Furthermore, the switched-capacitor circuit in accordance with Embodiment 2 can be mounted easily on a semiconductor integrated circuit and can attain excellent economic efficiency, stability and transient response.

### Embodiment 3

In the above-mentioned Embodiment 1, the switched-capacitor circuit 19 functions as a resistor, and the equivalent resistance R having a large resistance value is obtained by making the capacitance C3 of the capacitor 64 smaller. Hence, the gain in the high frequency region (at the resonance frequency fL in particular) is lowered, whereby the influence of a ringing phenomenon is eliminated, and the negative feedback operation of the entire switching power supply circuit is stabilized. However, there is a limit in making the capacitance of the capacitor 64 smaller. If the capacitance is decreased to 0.2 pF or less, the switched-capacitor circuit 19 does not fulfill its intrinsic function owing to the influence of wiring capacitances associated with wiring materials. As a result, the frequency characteristic cannot be determined by using only the switched-capacitor circuit 19 and the feedback capacitance, thereby having a problem of causing oscillation owing to variation during mass production. A switching power supply circuit in accordance with Embodiment 3 for solving this kind of problem will be described below.

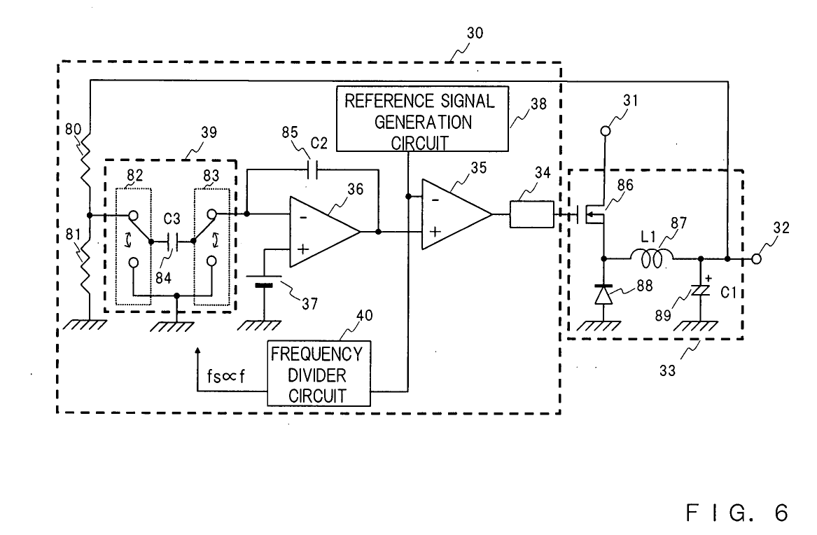

FIG. 6 is a block diagram showing the configuration of the switching power supply circuit in accordance with Embodiment 3 of the present invention.

As shown in FIG. 6, the switching power supply circuit in accordance with Embodiment 3 has a configuration wherein a frequency divider circuit 40, to which the reference signal of a reference signal generation circuit is input, for controlling a switched-capacitor circuit is additionally provided in the configuration of the switched-capacitor circuit in accordance with the above-mentioned Embodiment 1.

The switching power supply circuit in accordance with Embodiment 3 is provided with an input terminal 31 to which a DC voltage is input and an output terminal 32 from which a predetermined DC output voltage is output. These input terminal 31 and output terminal 32 are provided for a voltage conversion section 33 comprising a power transistor 86, a coil 87, a diode 88 and an output smoothing capacitor 89. In addition, this switching power supply circuit is provided with a drive signal control section 30 for subjecting the power transistor 86 to ON/OFF operation (chopping operation) using a pulse-width modulated pulse signal. The drive signal control section 30 comprises a pre-drive circuit 34, a pulse width modulation circuit 35, an error amplification circuit 36, a reference voltage circuit 37 for generating a reference voltage, a reference signal generation circuit 38 for generating a reference signal, output voltage setting resistors 80 and 81, a switched-capacitor circuit 39, and the frequency divider circuit 40.

In Embodiment 3 shown in FIG. 6, the switched-capacitor circuit 39 carries out sampling operation using the output signal of the frequency divider circuit 40. Since the other respects in Embodiment 3 are the same as those in the above-mentioned Embodiment 1 shown in FIG. 1, it will be easily understood that measures against oscillation can also be taken in Embodiment 3 in a way similar to those in the above-mentioned Embodiment 1. The sampling operation will thus be described below.

Since the frequency divider circuit 40 divides the frequency of the output signal of the reference signal generation circuit 38 at a predetermined frequency division ratio, the sampling frequency fs is proportional to the reference signal from the reference signal generation circuit 38 (fs oc f). It is thus possible to generate a sampling signal having a frequency lower than the operation frequency f of the reference signal. Hence, as the sampling frequency fs lowers, the equivalent resistance R can be made larger in inversely proportional to it as understood from the expression (3) described in the above-mentioned Embodiment 1. For this reason, even in the case that the capacitance C3 of the capacitor 84 in the switched-capacitor circuit 39 is made relatively large, the equivalent resistance R can have a large value. As a result, the equivalent resistance R can be set without being influenced by wiring capacitances associated with wiring materials. Therefore, in the case when the switching power supply circuit is formed on a printed circuit board, or is integrated in a semiconductor integrated circuit, stable circuit operation can be realized.

Moreover, a load response for stabilizing DC output voltage in response to fluctuation of the DC output voltage due to load fluctuation is important for a switching power supply circuit. In the load response, when a repetition frequency for controlling PWM, that is, a frequency of the reference signal is raised, quick response to load fluctuation can be obtained; and when the frequency is lowered, it is difficult to follow load fluctuation.

In the switching power supply circuit in accordance with Embodiment 3, the sampling frequency of the switched-capacitor circuit can be lowered at the rate of the dividing ratio of the frequency divider circuit without lowering the frequency of the reference circuit. As a result, measures against oscillation of negative feedback operation can be taken easily without sacrificing the response to load fluctuation.

Modification examples obtained by applying the configuration of Embodiment 3 will be described below using concrete numeric values.

For example, in the case that the frequency divider circuit 40 for carrying out 1/8 frequency division is used as Modification example 1, the sampling operation is performed at the sampling frequency fs, that is, 1/8 frequency of the operation frequency f of the reference signal. Hence, even in the case that the capacitance C3 having the same value as that in the above-mentioned Embodiment 1, the equivalent resistance R eight times as high as that obtained in Embodiment 1 can be obtained, and the zero-cross frequency fz1 can be shifted to 1/8 of the frequency. As a result, measures against oscillation can be taken easily in the switching power supply circuit in accordance with Modification example 1.

Furthermore, in the case that operation is carried out using the reference signal having the same frequency as that in Embodiment 1, the equivalent resistance R having the same resistance value as that in Embodiment 1 can also be obtained even in Modification example 2 in which the capacitance C3 eight times as high as that in Embodiment 1 is used. In this Modification example 2, in the case that a circuit is formed on a printed circuit board or a semiconductor substrate, the circuit operation is hardly affected by wiring capacitances. As a result, the switching power supply circuit can be mass-produced with uniform quality with little influence of variation during production.

In addition, in the case that the frequency divider circuit 40 for carrying out 1/8 frequency division is used as Modification example 3 and that the capacitance C3 four times as high as that in Embodiment 1 is used, the equivalent resistance R is two times as high as that in Embodiment 1 according to the above-mentioned expression (3). Hence, the zero-cross frequency fz1 can be shifted to 1/2 of the frequency. In this case, even if the capacitance value four times as high as that in Embodiment 1 is used, the zero-cross frequency fz can be shifted to the low frequency region side. The switching power supply circuit in accordance with Modification example 3 can be designed excellently so as to be provided with the effects of both the above-mentioned Modification examples 1 and 2. The effects are that the phenomenon of oscillation hardly occurs and that the stability of the circuit operation is hardly affected by wiring capacitances in comparison with the switching power supply circuit in accordance with the above-mentioned Embodiment 1.

In addition, in the case that the frequency division ratio of the frequency divider circuit 40 in accordance with Embodiment 3 is 1/2 or more, similar effects can be obtained. However, in the case that the sampling frequency fs of the switched-capacitor circuit 39 is low, the response for stabilizing the DC output voltage is degraded when the load current flowing through a load connected to the output terminal 2 fluctuates. Hence, in consideration of the response to the load fluctuation, it is preferable to adopt a frequency divider circuit having a frequency division ratio in the range of 1/2 to 1/16.

In the above-mentioned Embodiments 1 to 3, the cases of using the in-phase switched-capacitor circuits (19, 29, 39) in which the switch on the input side and the switch on the output side are subjected to switching operation in the same phase have been described. However, even if a switched-capacitor circuit for carrying out switching operation in opposite phase, the operation is carried out similarly, and similar effects are obtained. Furthermore, the switching power supply circuit in accordance with the present invention is not limited to have the above-mentioned switched-capacitor circuit. Even if a switched-capacitor circuit that is additionally provided with extra switches to suppress switching noise is used as another type. Moreover, in the above-mentioned Embodiments 1 to 3, it is assumed that a silicon diode or a schottky diode is used as a rectifier diode (68, 78, 88 and D1). However, it is possible to replace the rectifier diode with a MOS transistor. By subjecting the MOS transistor to ON/OFF operation in the phase opposite to that of the chopping operation of the power transistor serving as a main switch, rectifying operation can be performed by the MOS transistor. Hence the effects similar to that of the rectifier diode are obtained. In the present invention, effects basically similar to the effects owing to the configuration of each of the above-mentioned embodiments are obtained. A desired circuit should only be adopted appropriately according to requested design specifications.

As described above, the present invention is a switching power supply circuit being used as a power supply circuit in an electronic apparatus. Since the switching power supply circuit is excellent in economic efficiency and stability, it is useful for portable telephones, portable electronic apparatuses, etc.

Although the present invention has been described with respect to its preferred embodiments in some detail, the disclosed contents of the preferred embodiments may change in the details of the structure thereof, and any changes in the combination and sequence of the components may be attained without departing from the scope and spirit of the claimed invention.

1. A switching power supply circuit for outputting a predetermined DC output voltage by carrying out chopping operation in which energy is stored in a coil and the stored energy is discharged from said coil, comprising:
an error amplification circuit for amplifying the error between said DC output voltage and a reference voltage,
a first capacitor connected across the input and output terminals of said error amplification circuit,
a pulse width modulation circuit for comparing a reference signal having an inclined waveform with the output signal of said error amplification circuit and for outputting a PWM signal,
a voltage conversion section, including at least said coil and a second capacitor for smoothing the energy discharged from said coil, for outputting said predetermined DC output voltage to a power output terminal by carrying out said chopping operation according to said PWM signal, and
a switched-capacitor circuit provided between said power output terminal and the input terminal of said error amplification circuit.

2. The switching power supply circuit in accordance with claim 1, wherein a third capacitor is provided across the input and output terminals of said switched-capacitor circuit.

3. The switching power supply circuit in accordance with claim 1, wherein said reference signal is a triangular wave signal or a sawtooth wave signal generated by a reference signal generation circuit.

4. The switching power supply circuit in accordance with claim 1, wherein the sampling signal of said switched-capacitor circuit is synchronized with said reference signal.

5. The switching power supply circuit in accordance with claim 1, further comprising a frequency divider circuit for dividing the frequency of said reference signal, wherein said switched-capacitor circuit is subjected to sampling operation using the output signal of said frequency divider circuit.

6. A semiconductor device integrating a switching power supply circuit for outputting a predetermined DC output voltage by carrying out chopping operation in which energy is stored in a coil and the stored energy is discharged from said coil, comprising:
an error amplification circuit for amplifying the error between said DC output voltage and a reference voltage,
a first capacitor connected across the input and output terminals of said error amplification circuit,
a pulse width modulation circuit for comparing a reference signal having an inclined waveform with the output signal of said error amplification circuit and for outputting a PWM signal,
a voltage conversion section, including at least said coil and a second capacitor for smoothing the energy discharged from said coil, for outputting said predetermined DC output voltage to a power output terminal by carrying out said chopping operation according to said PWM signal, and
a switched-capacitor circuit provided between said power output terminal and the input terminal of said error amplification circuit, wherein
at least said error amplification circuit, said first capacitor, said pulse width modulation circuit and said switched-capacitor circuit are formed inside one semiconductor substrate.

7. The semiconductor device in accordance with claim 6, wherein a third capacitor connected across the input and output terminals of said switched-capacitor circuit is formed inside said semiconductor substrate.

8. The semiconductor device in accordance with claim 6, wherein said reference signal is a triangular wave signal or a sawtooth wave signal generated by a reference signal generation circuit.

9. The semiconductor device in accordance with claim 6, wherein the sampling signal of said switched-capacitor circuit is synchronized with said reference signal.

10. The semiconductor device in accordance with claim 6, further comprising a frequency divider circuit for dividing the frequency of said reference signal, wherein said switched-capacitor circuit is subjected to sampling operation using the output signal of said frequency divider circuit.
